(19) United States
(12) Patent Application Publication
(10) Pub. No.: US 2018/0158023 A1
(43) Pub. Date: Jun. 7, 2018

(54) PROJECT-RELATED ENTITY ANALYSIS

(71) Applicant: Microsoft Technology Licensing, LLC, Redmond, WA (US)

(72) Inventor: Shahil Soni, Seattle, WA (US)

(73) Assignee: Microsoft Technology Licensing, LLC, Redmond, WA (US)

(21) Appl. No.: 15/368,468

(22) Filed: Dec. 2, 2016

(51) Int. Cl. G06Q 10/10; G06F 17/30; H04L 12/58; G06Q 10/06; G06F 17/27

(52) U.S. Cl. CPC G06Q 10/103; G06F 17/30011; H04L 51/16; G06F 3/0482; G06Q 10/063114; G06F 17/2705; H04L 51/08

(57) ABSTRACT

A professional development dashboard is provided. A professional development dashboard generator parses various collaborative communications for identifying a project, and collects and analyzes data associated with the project for summarizing the project, summarizing the user's performance relating to the project, and for providing suggested professional development improvements to the user based on the user's performance.

### BACKGROUND

For many computing device users, their work takes place in their collaborative communications. For example, a user's work associated with a given project is oftentimes interspersed in email communications and attachments, meetings in the user's calendar, meeting transcripts, documents authored by or shared with the user within the duration of the project, etc. Computing device users oftentimes do not keep track of their performance associated with work for a given project; however, this could be useful when building and enhancing one's professional development. For example, collection and analysis of data relating to a user's performance associated with a project could inform the user of skills that the user utilized during the project and could identify skills that the user may be lacking and would benefit the user to address for the user's professional development.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer readable storage device for collecting and analyzing data associated with a user's project performance for generating a dashboard relating to the user's professional development. A professional development dashboard generator parses various electronic documents for identifying a project, and collects and analyzes data associated with the project for summarizing the project, summarizing the user's performance relating to the project, and provides suggested professional development improvements to the user based on his/her performance.

Examples are implemented as a computer process, a computing system, or as an article of manufacture such as a device, computer program product, or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram showing an example operating environment including components of a system for generating a professional development dashboard associated with a user's project performance;

FIG. 2 is an illustration of an example professional development dashboard user interface;

FIG. 3 is a flow chart showing general stages involved in an example method for generating a professional development dashboard associated with a user's project performance;

FIG. 4 is a block diagram illustrating example physical components of a computing device;

FIGS. 5A and 5B are simplified block diagrams of a mobile computing device; and

FIG. 6 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage media for generating a professional development dashboard associated with a user's project performance. A professional development dashboard generator parses various collaborative communications for identifying a project, and collects and analyzes data associated with the project for summarizing the project, summarizing the user's performance relating to the project, and provides suggested professional development improvements to the user based on his/her performance. Advantageously, the professional development dashboard generator provides a single interface via which the user is enabled to efficiently access documents associated with the project, collaborators associated with the project, and for viewing performance and professional development data. Because the user is not required to manually examine various collections of communications and documents for identifying projects and collecting data relating to identified projects, less memory and fewer processing resources are expended, and the functionality of the computing device is thereby expanded and improved.

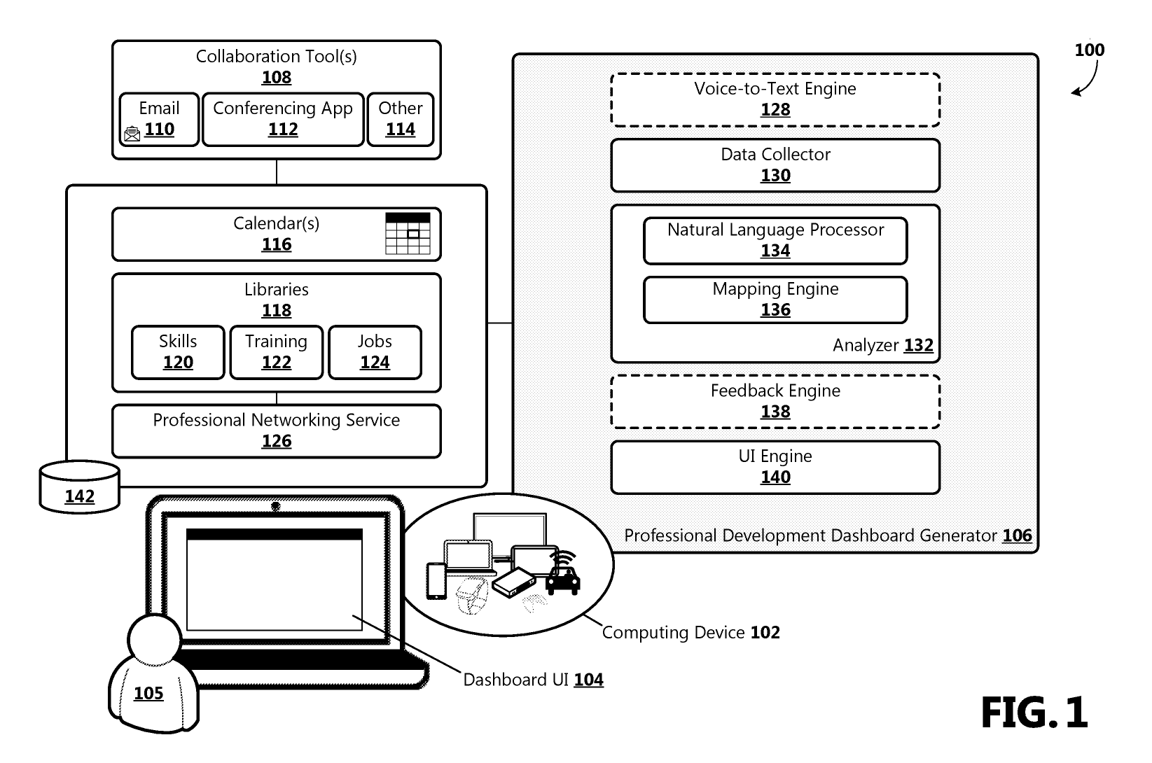

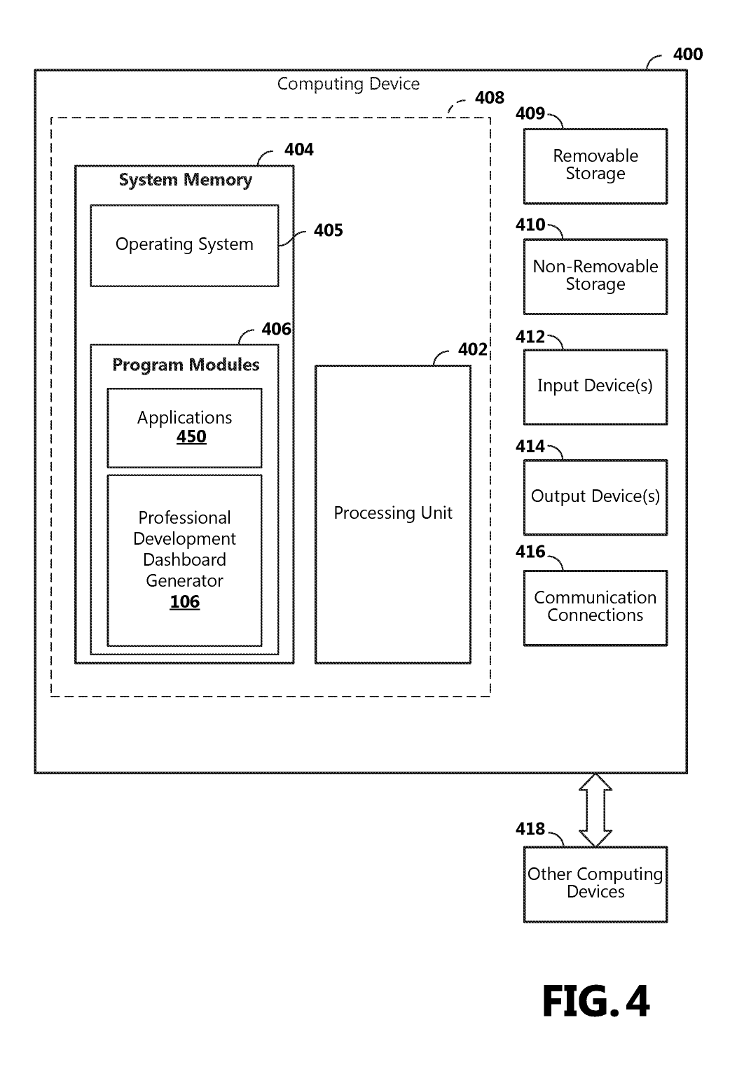

With reference now to FIG. 1, a block diagram of an example operating environment 100 illustrating aspects of an example system for generating a professional development dashboard 104 associated with a user's project performance is shown. The example operating environment 100 includes an electronic computing device 102. The computing device 102 illustrated in FIG. 1 is illustrated as a laptop computing device; however, as should be appreciated, the computing device 102 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, or other type of computing device) for executing applications for performing a variety of tasks. The hardware of these computing devices is discussed in greater detail in regard to FIGS. 4, 5A, 5B, and 6.

According to aspects, the computing device 102 includes or is in communication with a professional development dashboard generator 106. The professional development dashboard generator 106 is illustrative of a software module, system, or device operative to analyze a user's project performance and to generate and provide a dashboard user interface (UI) 104 relating to the user's professional development. In one example, the computing device 102 includes a professional development dashboard generator application programming interface (API), operative to enable an application to employ project performance analysis and professional development dashboard generation via stored instructions.

According to an aspect, the professional development dashboard generator 106 comprises a data collector 130, operative to collect electronic documents associated with the user 105 from one or more data sources 142. An electronic document may be one of various types of documents. In one example, the data collector 130 collects collaboration communication data generated or received via one or more collaboration tools 108. For example, the user 105 may utilize various collaboration tools 108 for collaborating with colleagues, such as an email application 110 for sending and receiving emails, a conferencing application 112 for communicating via audio calls, video calls, or instant messages, or other collaboration applications 114 for enabling users to engage in electronic conversations and to share project-related documents. The user's work associated with various projects may be interspersed in amongst various electronic communications, conversations, and attachments, meetings in the user's calendar 116, meeting transcripts, documents authored by or shared with the user, etc.

The data collector 130 is illustrative of a software module, system, or device operative to collect electronic documents and data generated or shared via the various collaboration tools 108 for analysis by an analyzer 132 for identifying one or more projects in which the user 105 is involved. For example, the data collector 130 may collect an email conversation thread or meeting invitations from the user's mailbox, or collect calendar items from the user's calendar 116. In some examples, a conversation between the user 105 and colleagues is conducted via an audio or video call using the conferencing application 112. According to an example, the conferencing application 112 may record the conversation, and the professional development dashboard generator 106 may optionally include a voice-to-text engine 128 operative to transcribe the conversation for analysis by the analyzer 132.

According to an aspect, the analyzer 132 is illustrative of a software module, system, or device operative to parse the data for keywords relating to one or more projects. In one example, the analyzer 132 is operative to parse electronic documents, such as collaborative communications (e.g., an email conversation, a messaging conversation, or a transcript), for identifying a project. In one example, the analyzer 132 is operative to parse a subject of an email conversation, and associate the email conversation subject with a title for a project. In another example, the analyzer 132 is operative to parse collaborative communications for recipients of the communications, and to associate the recipients as participants of the identified project. In another example, the analyzer 132 is operative to parse collaborative communications for a date associated with a first communication within a conversation, as well as, a date associated with a last communication within the conversation, and to assign the dates as a duration of the identified project.

In another example, the analyzer 132 is operative to parse communication items in the user's mailbox 110 for identifying collaboration locations or locations where the user 105 collaborated with other project participants for the identified project. For example, the analyzer 132 may parse communication items comprising travel information to various locations, calendar items in the user's calendar 116 for meeting locations, or locations identified by a location determining tool for identifying locations where the user worked or collaborated on the project. In some examples, collaboration locations include locations of project participants.

In another example, the analyzer 132 is operative to parse collaborative communications for identifying a number of communications associated with an identified project, parse items in the user's calendar for identifying an amount of time spent in meetings associated with the project, parse metadata of electronic documents attached to collaborative communications or shared with project participants, or parse metadata of electronic documents stored in other data sources 142 for identifying amounts of time the user 105 has worked on the project. Based on the identified amount of time, the analyzer 132 is operative to determine an intensity level correlating to the user's performance on the project, for example, on a per day, per week, per month, or per year basis over the duration of the project.

In some examples, the analyzer 132 includes or is communication with a natural language processor 134, operative to apply natural language processing to the data for identifying and parsing keywords from collaborative communications data or other electronic documents for identifying a set of skills utilized by the user 105 in relation to the project. In some examples, the analyzer 132 further includes a mapping engine 136 for mapping the content of the user's collected collaborative communications to one or more libraries 118, such as a skills library 120 for recognizing skills utilized by the user 105 during the duration of the project. In one example, the analyzer 132 recognizes skills that are mentioned in the user's electronic documents or collected collaborative communications. In another example, the analyzer 132 uses natural language processing to determine skills based in part on the context of the electronic document or communication. The libraries 118 may be populated from one or more data sources 142.

According to one example, the mapping engine 136 is operative to reference one or more external resources, such as an account or profile associated with the user 105 on a professional networking service 126 for aiding in determining skills utilized by the user. For example, information in the user's professional networking service 126 profile may indicate that the user 105 is a mechanical engineer, and an email conversation thread may include discussions about the user using a particular computer aided design (CAD) software program and may include attached CAD documents. Accordingly, the analyzer 132 may determine that the user 105 utilized CAD drafting skills for the project. Additionally, the mapping engine 136 may reference the user's professional networking service 126 profile to identify a list of skills that the user 105 has listed as already having for identifying skills that the user has acquired while working on the project. For example, the user's profile may include that the user 105 knows a particular CAD program, A-CAD. Analysis of the user's collaborative communications or of other electronic documents related to the project may indicate that the user 105 used B-CAD for the project. Accordingly, the analyzer 132 may determine that the user 105 has acquired a new skill—B-CAD.

According to an aspect, the mapping engine 136 is operative to map the user's identified and listed skills to a jobs library 124 for identifying a set of professional skills associated with the user's profession. According to an example, the set of professional skills include skills that other individuals in similar roles inside or outside of the user's organization have. The user's role may be determined based on the user's profile or on the set of identified skills or the skills listed in the user's profile. In some examples, the jobs library 124 is populated from job posting data sources 142 inside or outside of the user's organization or from a professional networking service 126 data source. According to an aspect, the analyzer 132 is operative to identify a skills gap between skills that the user 105 has and the set of professional skills. In some examples, the mapping engine 136 is further operative to reference a training library 122 for identifying training opportunities for the user based on the identified skills gap. For example, the training library 122 may be populated from training service data sources 142 inside or outside of the user's organization or from a professional networking service 126 data source. In some examples, the analyzer 132 is operative to determine training opportunities that are relevant to the user 105 based on the user's calendar 116, location, etc. For example, upon identifying available training opportunities, the analyzer 132 is operative to search the user's calendar 116 for determining which training opportunities the user 105 may be able to attend or have time to commit to based on his/her schedule.

In some examples, the professional development dashboard generator 106 further comprises a feedback engine 138, illustrative of a software module, system, or device operative to identify one or more project participants to send feedback requests to on behalf of the user 105. For example, it is oftentimes useful to the user 105 to receive performance feedback for the user's work on a given project, which the user is enabled to use for his/her professional development. According to an aspect, the project participants are identified based on calendar events, meetings, or email communications. In some examples, the feedback engine 138 is further operative to automatically send feedback requests to the identified project participants. Feedback requests may be automatically sent upon completion of the project or at predetermined intervals during the project. In some examples, the feedback engine 138 is further operative to automatically track receipt of feedback request responses.

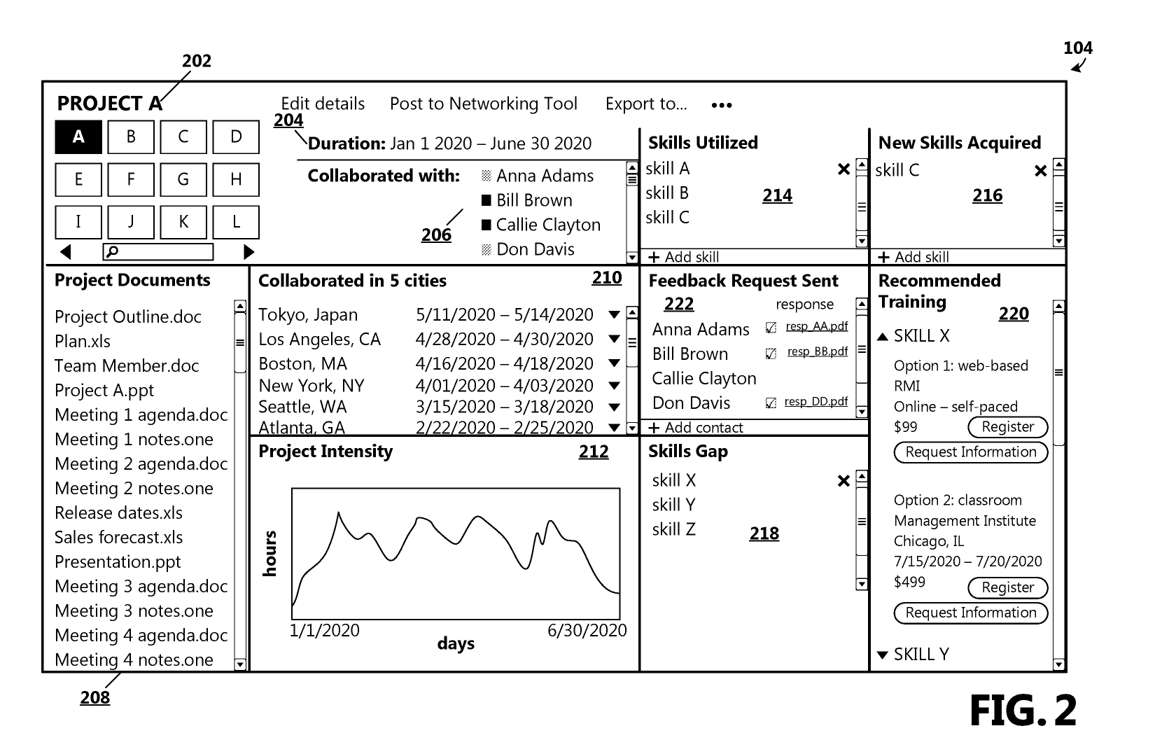

According to aspects, the professional development dashboard generator 106 further comprises a user interface (UI) engine 140, illustrative of a software module, system, or device operative to generate a dashboard UI 104 for displaying data relating to the user's performance associated with the project, and for displaying professional development goals identified by the analyzer 132. According to an aspect, presenting user performance data and professional development goals to the user 105 in a single dashboard UI 104 enables the user to efficiently access his/her project performance, recommended training, and various documents and project participants associated with the project. An example of the dashboard UI 104 is illustrated in FIG. 2.

With reference now to FIG. 2, an example dashboard UI 104 generated by aspects of the professional development dashboard generator 106 and displayed by the client computing device 104 is shown. The illustrated dashboard UI 104 example includes a project title 202, for example, as determined from the subject of a collaborative communication collection, such as an email thread. Further, the illustrated dashboard UI 104 example includes a duration of the project. As described above, the duration may be determined from a first date of a first communication in the collaborative communication collection and a last date of the last communication in the collaborative communication collection. The example dashboard UI 104 includes a list of project participants 206 that are identified from the collaborative communication collection, meeting invitations, calendar items, document metadata, etc. According to an example, the project participant 206 names included in the list are selectable, wherein selection of a project participant name causes a display of additional information about the project participant or information about the connection between the user 105 and the project participant.

The example dashboard UI 104 further includes a list of documents 208 associated with the project, which may include documents attached to the collaborative communication collection, documents associated with links shared in the collaborative communication collection, documents stored in a data store associated with the user that were authored by the user 105 during the project duration 204 and that are determined to be related to the project, etc. According to an example, the documents 208 are selectable, wherein selection of a document provides a preview of the document or causes the document to open in an appropriate application.

Further, the illustrated dashboard UI 104 example includes a list of locations 210 in which the user 105 collaborated with other project participants within the duration of the project. For example, the locations 210 may be identified from communication items comprising travel information to various locations, calendar items in the user's calendar 116 for meeting locations, or locations identified by a location determining tool for identifying locations where the user worked or collaborated on the project. In some examples, collaboration locations include locations of project participants. For example, if the user 105 has an online meeting with a participant in a different city, the city may be included in the list of locations 210. In some examples, additional information may be provided, such as meeting agendas, meeting notes, meeting transcripts, or documents attached to meeting invitations for meetings associated with the collaborative locations 210.

The illustrated dashboard UI 104 example includes various information elements corresponding to the user's project performance. For example, the illustrated dashboard UI 104 example includes a graphical representation of the user's work intensity 212 relating to project work. In some examples and as illustrated, the work intensity 212 graphical representation is embodied as a graph or chart that illustrates the amount of work produced by the user 105 associated with the project within the duration of the project or the amount of time spent by the user on project-related work, meetings, or tasks. For example, the graphical representation of the user's work intensity 212 correlates to the user's performance on the project on a per day, per week, per month, or per year basis over the duration of the project.

The illustrated dashboard UI 104 example further includes a list of skills utilized 214 by the user 105 while working on the project. As described above the list of skills utilized 214 by the user 105 may be determined from skills that are mentioned in the user's collected collaborative communications or by using natural language processing to determine skills based in part on the context of collaborative communications or project documents.

Further, the illustrated dashboard UI 104 includes a list of skills acquired 216 by the user 105 while working on the project. In one example, the list of skills acquired 216 by the user 105 is determined by a comparison between skills that are identified as skills that the user had prior to working on the project and the list of skills utilized 214 by the user 105 while working on the project. For example, the user's professional networking service 126 profile may be referenced for identifying the skills that the user had prior to working on the project.

The illustrated dashboard UI 104 example further includes a list of skills gap 216 skills, where skills gap skills include a list of skills that are identified as skills that may be beneficial to the user's professional development but that the user 105 may be lacking. According to an example, skills gap 216 skills are determined by comparing a set of skills associated with the user and a list of professional skills. For example, the set of skills associated with the user includes skills that the user had prior to working on the project, skills utilized 214 by the while working on the project, and skills acquired 212 by the user while working on the project. The list of professional skills may include skills that other individuals in similar roles inside or outside of the user's organization have.

Further, the illustrated dashboard UI 104 includes a list of training opportunities 220 recommended for the user 105 based on the user's identified skills gap 218. In one example, the training opportunities 220 included in the list may include training programs that have been identified as training for a skill that the user 105 lacks and that fitting within the user's schedule. In another example, the list may include training programs that are located near the user or that are web-based.

The example dashboard UI 104 further includes a feedback 222 section including a list of project participants 206 who have received a feedback request for providing feedback on the user's project performance. The feedback 222 section may further include information associated with receipt of feedback responses. In one example, participants' feedback responses may be accessed via the dashboard UI 104. As should be appreciated the example dashboard UI 104 illustrated in FIG. 2 is for illustrative purposes. Other UI configurations are possible and are within the scope of the present disclosure.

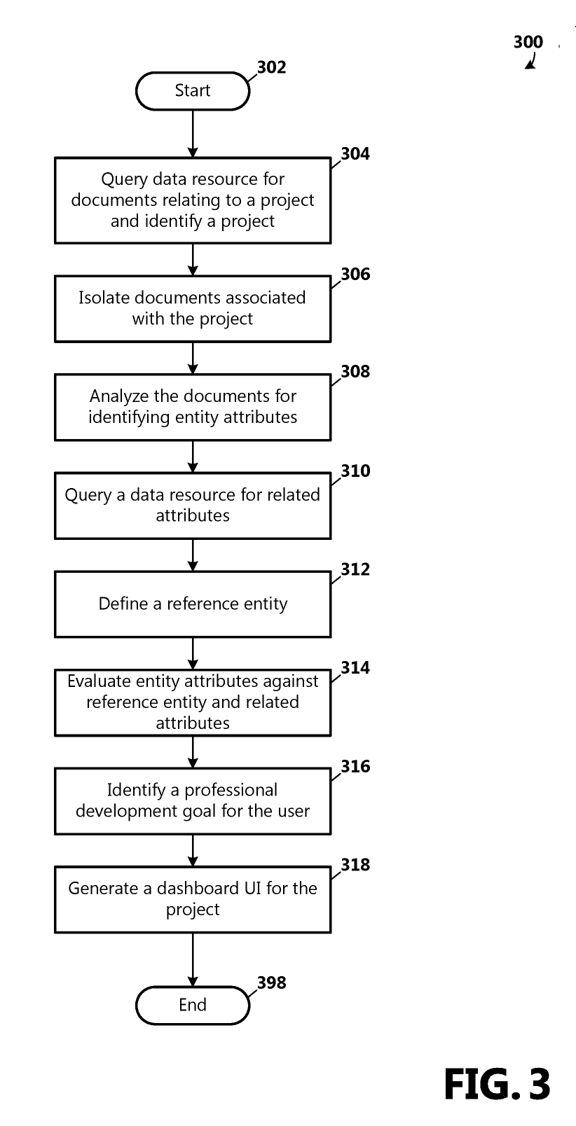

Having described an operating environment and an example user interface display example with respect to FIGS. 1-2, FIG. 3 is a flow chart showing general stages involved in an example method 300 for generating a professional development dashboard associated with a user's project performance. With reference now to FIG. 3, the method 300 begins at start OPERATION 302, and proceeds to OPERATION 304, where a data resource is queried for electronic documents relating to a project. For example, aspects of the professional development dashboard generator 106 collect electronic documents associated with the user 105 and collaboration communication data from one or more collaboration tools 108, and parse the collected data for identifying a project worked on by the user. In one example, aspects of the professional development dashboard generator 106 query a relational graph maintained by a graph database for finding electronic documents that have been authored by or interacted with by the user 105 or collaborative communications directed to or authored by the user.

In a graph database, entities are presented as nodes and relationships between those entities are presented as edges in a view of a relational graph maintained by the graph database. The relational graph may be periodically queried via graph queries to learn about the relationships between entities. For example, a graph query may be issued to find friends or contacts within a social network, the documents that a given user has interacted with, the users that a given document has been accessed by, the entities that satisfy various search criteria, etc. A relational graph includes nodes describing entities and a set of accompanying properties of those entities, such as, for example, the names, titles, ages, addresses, etc. Each property can be considered a key/value pair—a name of the property and its value. In other examples, entities (e.g., users, documents, meetings, and communications) are represented as nodes, and are connected to other nodes by edges representing relations among these entities. For example, an edge between a person node and a document node may represent that person's authorship, modification, or viewing of the document. Aspects of the professional development dashboard generator 106 parse email conversation threads, meeting invitations, calendar items, meeting information, or other electronic documents for identifying a project. According to one example, aspects of the professional development dashboard generator 106 identify a project related to the user 105 based on a conversation thread.

The method 300 proceeds to OPERATION 306, where aspects of the professional development dashboard generator 106 isolate electronic documents associated with the identified project based on query criteria. In one example, communication items associated with the identified project are isolated. In another example, calendar items associated with the identified project are isolated. In another example, electronic documents authored by or interacted with by the user 105 are isolated.

The method 300 proceeds to OPERATION 308, where aspects of the professional development dashboard generator 106 analyze the isolated data for identifying one or more entity attributes. For example, aspects of the professional development dashboard generator 106 analyze the isolated data for determining the project's duration, project participants 206, documents 208 associated with the project, locations 210 where the user collaborated on the project with other project participants, the user's work intensity 212, skills utilized 214 by the user while working on the project, and a list of project participants to send feedback requests to on behalf of the user 105.

The method 300 proceeds to OPERATION 310, where aspects of the professional development dashboard generator 106 query a data source 142 for related attributes, for example, to determine professional skills. For example, aspects of the professional development dashboard generator 106 may query an internal data source 142 or a data source 142 associated with a professional networking service 126 for identifying skills associated with individuals who have a similar job title or job functions as the user 105. In another example, aspects of the professional development dashboard generator 106 may query a data source 142 associated with a jobs posting site or a jobs library 124 for identifying skills that employers are seeking in candidates for jobs in the user's career field. According to an example, aspects of the professional development dashboard generator 106 may query a data source 142 associated with a professional networking service 126, such as the user's profile with the professional networking service for identifying skills that the user 105 had prior to working on the project. For example, this information can be used by aspects of the professional development dashboard generator 106 for evaluating against the skills used by the user 105 while working on the project for determining skills that the user acquired while working on the project.

The method 300 proceeds to OPERATION 312, where a reference entity is defined. According to an aspect, the reference entity is defined by attributes including the skills associated with individuals who have a similar job title or job functions as the user 105 and skills that employers are seeking in candidates for jobs in the user's career field.

At OPERATION 314, aspects of the professional development dashboard generator 106 evaluate entity attributes against attributes associated with the reference entity. For example, the professional development dashboard generator 106 may compare skills that the user 105 has against skills associated with individuals who have a similar job title or job functions as the user 105 or skills that employers are seeking in candidates for jobs in the user's career field.

At OPERATION 316, aspects of the professional development dashboard generator 106 determine a professional development goal for the user. According to an aspect, a skills gap 218 between skills the user has and skills the user needs to be competitive in the user's career field are determined via the evaluation of the entity attributes against attributes associated with the reference entity. For example, responsive to an evaluation of the skills that the user 105 has against skills associated with individuals who have a similar job title or job functions as the user or skills that employers are seeking in candidates for jobs in the user's career field, one or more development skills may be determined as opportunities for the user to further develop his/her career. Further, aspects of the professional development dashboard generator 106 determine training opportunities 220 available to the user 105 for developing skills identified in the user's skills gap 218.

The method 300 proceeds to OPERATION 318, where a dashboard UI 104 including project-related information identified and determined by aspects of the professional development dashboard generator 106 is generated and displayed on a screen of the user's computing device 102. For example, the dashboard UI 104 may include one or more pieces of information, such as illustrated in the example dashboard UI illustrated in FIG. 2. The method 300 ends at OPERATION 398.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes the professional development dashboard generator 106. The operating system 405, for example, is suitable for controlling the operation of the computing device 400. Furthermore, aspects are practiced in conjunction with a graphics library, other operating systems, or any other application program, and is not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 (e.g., professional development dashboard generator 106) perform processes including, but not limited to, one or more of the stages of the method 300 illustrated in FIG. 3. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 4 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 400 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

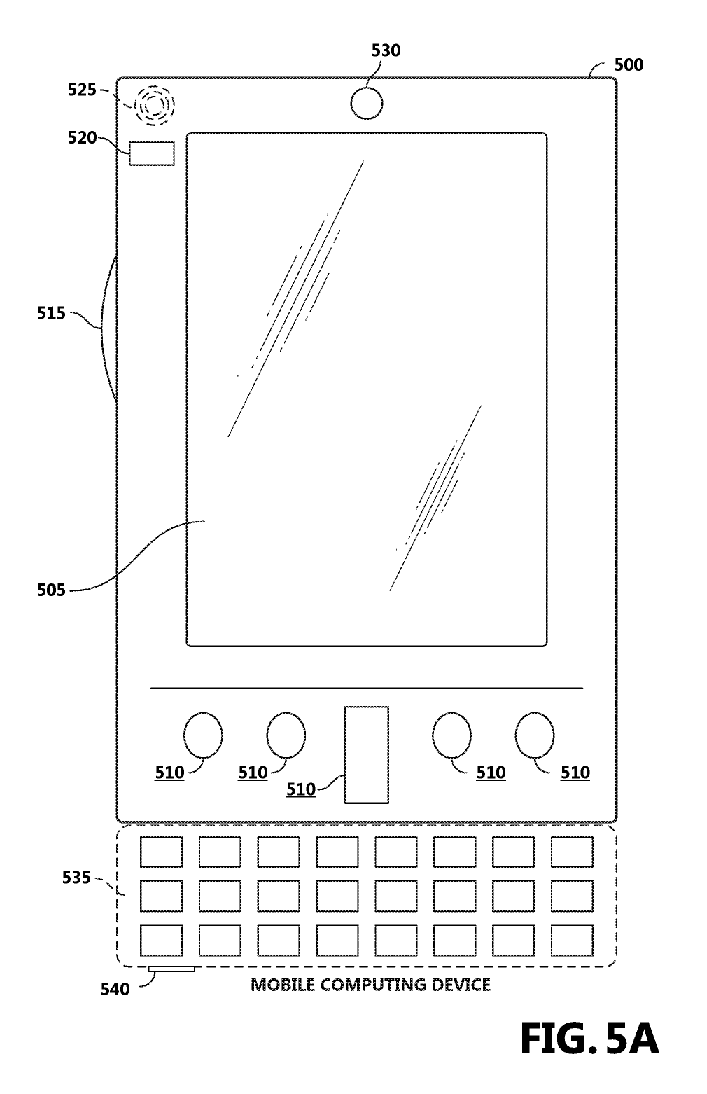

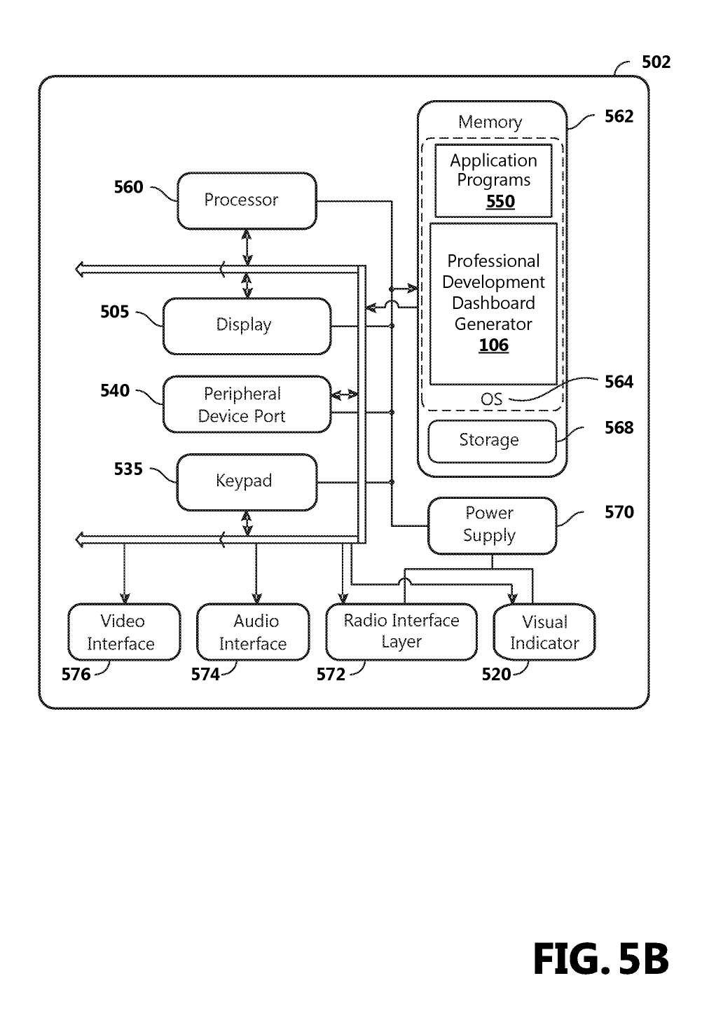

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or less input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. According to an aspect, the professional development dashboard generator 106 is loaded into memory 562. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 is stored locally on the mobile computing device 500, as described above. According to another aspect, the data is stored on any number of storage media that is accessible by the device via the radio 572 or via a wired connection between the mobile computing device 500 and a separate computing device associated with the mobile computing device 500, for example, a server computer in a distributed computing network, such as the Internet. As should be appreciated such data/information is accessible via the mobile computing device 500 via the radio 572 or via a distributed computing network. Similarly, according to an aspect, such data/information is readily transferred between computing devices for storage and use according to well-known data/information transfer and storage means, including electronic mail and collaborative data/information sharing systems.

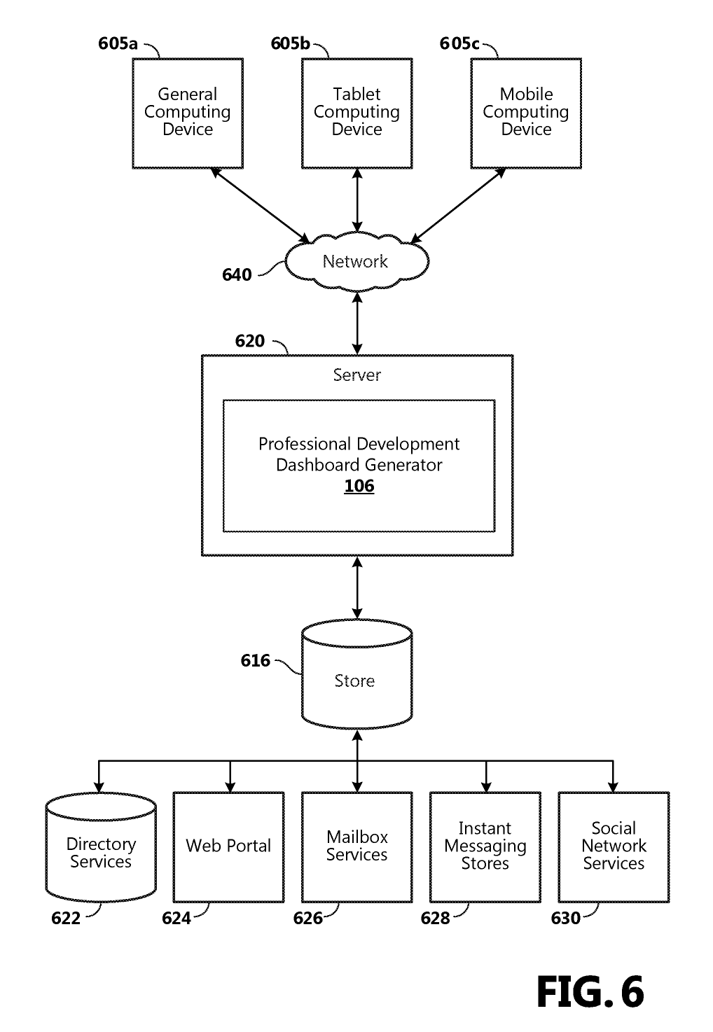

FIG. 6 illustrates one example of the architecture of a system for generating a professional development dashboard associated with a user's project performance as described above. Content developed, interacted with, or edited in association with the professional development dashboard generator 106 is enabled to be stored in different communication channels or other storage types. For example, various documents may be stored using a directory service 622, a web portal 624, a mailbox service 626, an instant messaging store 628, or a social networking site 630. The professional development dashboard generator 106 is operative to use any of these types of systems or the like for generating a professional development dashboard associated with a user's project performance, as described herein. According to an aspect, a server 620 provides the professional development dashboard generator 106 to clients 605a,b,c. As one example, the server 620 is a web server providing the professional development dashboard generator 106 over the web. The server 620 provides the professional development dashboard generator 106 over the web to clients 605 through a network 640. By way of example, the client computing device is implemented and embodied in a personal computer 605a, a tablet computing device 605b or a mobile computing device 605c (e.g., a smart phone), or other computing device. Any of these examples of the client computing device are operable to obtain content from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for providing performance analysis for professional development of a user, comprising:
initiating a query on a data source for electronic documents relating to a project;
identifying the project;
isolating responsive electronic documents based on query criteria;
performing an analysis on the responsive electronic documents to identify one or more entity attributes;
querying a data source for related attributes;
defining a reference entity associated with a set of desired entity attributes;
evaluating the one or more entity attributes against the set of desired entity attributes for identifying a professional development goal for a user; and
generating a dashboard user interface displaying project-related information including the professional development goal for the user.

2. The computer-implemented method of claim 1, wherein performing an analysis on the responsive electronic documents comprises:
parsing content of the responsive electronic documents for keywords; and
mapping the keywords to one or more libraries for determining one or more skills utilized by the user.

3. The computer-implemented method of claim 1, wherein determining a professional development goal for the user comprises:
identifying a set of skills associated with the user, wherein the set of skills includes skills included in a professional profile associated with the user and skills utilized by the user within the project's duration;
collecting a list of professional skills from one or more data sources;
comparing the set of skills associated with the user to the list of professional skills; and
identifying a skills gap between the set of skills associated with the user and the list of professional skills, wherein the skills gap includes one or more skills that the user lacks that are associated with individuals who have a similar job title or job functions as the user or skills that employers are seeking in candidates for jobs in the user's career field.

4. The computer-implemented method of claim 3, wherein collecting the list of professional skills from one or more data sources comprises collecting the list of professional skills based on at least one of:
the project;
the user's job title;
the set of skills associated with the user; and
a professional profile associated with the user.

5. The computer-implemented method of claim 3, further comprising:
searching one or more external sources for training options associated with the identified skills gap; and
including the training options in the user interface display.

6. The computer-implemented method of claim 5, further comprising:
searching the user's calendar for time availability; and
searching one or more external sources for training options based on the user's time availability.

7. The computer-implemented method of claim 1, further comprising:
analyzing the responsive electronic documents to determine one or more new skills acquired by the user within the project's duration; and
including the one or more skills acquired by the user in the user interface display.

8. The computer-implemented method of claim 1, wherein generating a dashboard user interface comprises displaying a list of documents associated with the project.

9. The computer-implemented method of claim 8, wherein displaying the list of documents associated with the project comprises displaying at least one of:
attached documents in an email thread associated with the project;
documents corresponding to links included in the email thread;
documents attached to meeting requests associated with the project;
documents collaborated on by the user and one or more recipients of emails in the email thread; and
documents collaborated on by the user and one or more attendees of meetings associated with the meeting requests.

10. The computer-implemented method of claim 1, wherein identifying the project comprises identifying the project based on collaboration communications.

11. The computer-implemented method of claim 10, wherein identifying the project based on collaboration communications comprises:
parsing collaboration communications for a subject;
creating a project title based on the subject; and
including the project title in the user interface display.

12. The computer-implemented method of claim 10, wherein identifying the project based on collaboration communications comprises:
parsing collaboration communications for recipients;
creating a list of project collaborators based on the recipients; and
including the list of project collaborators in the user interface display.

13. A system for providing performance analysis for professional development of a user, the computing device comprising:
at least one processing device; and
at least one computer readable data storage device storing instructions that, when executed by the at least one processing device, cause the computing device to:
initiate a query on a data source for electronic documents relating to a project;
identify the project;
isolate responsive electronic documents based on query criteria;
perform an analysis on the responsive electronic documents to identify one or more entity attributes;
query a data source for related attributes;
define a reference entity associated with a set of desired entity attributes;
evaluate the one or more entity attributes against the set of desired entity attributes for identifying a professional development goal for a user; and
generate a dashboard user interface displaying project-related information including the professional development goal for the user.

14. The system of claim 13, wherein in identifying the project, the system is operative to:
parse collaboration communications for a subject;
create a project title based on the subject; and
include the project title in the user interface display.

15. The system of claim 13, wherein in performing an analysis on the responsive electronic documents, the system is operative to:
parse content of the electronic documents for keywords; and
map the keywords to one or more libraries for determining one or more skills utilized by the user.

16. The system of claim 13, wherein in determining a professional development goal for the user, the system is operative to:
identify a set of skills associated with the user, wherein the set of skills includes skills included in a professional profile associated with the user and skills utilized by the user within the project's duration;
collect a list of professional skills from one or more data sources based on at least one of:
the project;
the user's job title;
the set of skills associated with the user; and
a professional profile associated with the user;
compare the set of skills associated with the user to the list of professional skills; and
identify a skills gap between the set of skills associated with the user and the list of professional skills.

17. The system of claim 16, wherein the system is further operative to:
search the user's calendar for time availability; and
search one or more external sources for training options associated with the identified skills gap based on the user's time availability; and
include the training options for display in the user interface display.

18. The system of claim 13, wherein the system is further operative to:
analyze the electronic documents to determine one or more new skills acquired by the user within the project's duration; and
include the one or more skills acquired by the user in the user interface display.

19. A computer readable storage device including computer readable instructions, which when executed by a processing unit is operative to:
initiate a query on a data source for electronic documents relating to a project;
identify the project;
isolate responsive electronic documents based on query criteria;
perform an analysis on the responsive electronic documents to identify one or more entity attributes;
query a data source for related attributes;
define a reference entity associated with a set of desired entity attributes;
evaluate the one or more entity attributes against the set of desired entity attributes for identifying a professional development goal for a user; and
generate a dashboard user interface displaying project-related information including the professional development goal for the user.

20. The computer readable storage device of claim 19, wherein the device is further operative to display at least one of:
a list of locations where the user collaborated with project participants on the project;
a graphical representation of the user's work intensity on the project;
a list of skills utilized by the user while working on the project;
a list of skills acquired by the user while working on the project;
a list of project participants who were sent feedback requests to on behalf of the user;
a list of skills in an identified skills gap between skills associated with the user and a list of professional skills; and
training opportunities available to the user for developing skills identified in the user's skills gap.
